(19) United States
(12) Patent Application Publication
(10) Pub. No.: US 2014/0367544 A1
(43) Pub. Date: Dec. 18, 2014

(54) MOBILE BASE SYSTEM AND METHODS FOR DISPLAYS

(71) Applicant: SAP PRODUCTS LTD, KWUN TONG (HK)

(72) Inventor: Daniel Graves, Torrance, CA (US)

(21) Appl. No.: 14/307,836

(22) Filed: Jun. 18, 2014

Related U.S. Application Data
(60) Provisional application No. 61/836,263, filed on Jun. 18, 2013.

(51) Int. Cl. G09F 19/00; F16M 11/20

(52) U.S. Cl. CPC G09F 19/00; F16M 11/2085; F16M 11/2092
USPC 248/346.02

(57) ABSTRACT

The invention is directed to systems and methods that allow for easy movement of point-of-sale merchandising units or displays, whether such a display is loaded with product or not. The invention provides systems and methods which allow adaptation to different point-of-sale merchandising systems to be easily moved.

This U.S. Patent Application claims priority to U.S. provisional patent application Ser. No. 61/836,263 filed on Jun. 18, 2013, which is incorporated herein by reference in its entirety.

### BACKGROUND

The present invention is directed to adjustable mobile base systems and methods for use in association with retail displays. More specifically, the present invention is directed to an adjustable add-on mobile base system for retail displays to improve mobility of the displays.

To facilitate impulse purchasing of products in retail environments, there have been developed product merchandising units which will accommodate one or more products for easy access by prospective customers. This is particularly true in the mobile society in which we live, where products are many times purchased for consumption on the go. As a result, point-of-sale merchandising units are widely used due to the greater flexibility provided with respect to where such merchandising units may be located. The strategic location of such units can have a significant impact on the sales of the articles or products. The ability to provide merchandising units immediately adjacent areas such as food counters, points of purchase, and other high customer traffic locations, provide better utilization of merchandising areas, and is important to the merchant.

Point-of-sale displays, such as those used in convenience stores, gas stations, grocery stores and other retail locations are generally constructed on site, such as from cardboard, plastic or other material, at the location at which it is to be used, and then loaded with products for purchase. After construction and loading such a display with product, it may be bulky, heavy, and is generally difficult to maneuver, such that the location of the display is pretty well fixed and is not readily changed, without extra labor and effort. In would be desirable to allow for the point-of-sale displays to be easily moved, even when loaded with products, to adjust the location at which the display is positioned to enhance the ability to sell the products therein. Removing the product from the display, moving the display, and restocking the point-of-sale display is undesirable and requires additional down-time, labor and cost.

### SUMMARY

There is thus a need for systems and methods that allow for easy movement of point-of-sale merchandising units or displays, whether such as display is loaded with product or not. Further, it would be desirable to provide systems and methods which allow different point-of-sale merchandising systems to be easily moved. It would be desirable to allow for an effective system to overcome the problems of fixed displays, and for these and other reasons, the present invention is directed to overcoming the problems set forth above.

### BRIEF DESCRIPTION OF DRAWINGS

FIG. 1 is a perspective view of a mobile base system according to an example of the invention in association with a point-of-sale display;

FIG. 2 is a perspective view of a mobile base system according to an example;

FIG. 3 is an exploded perspective view of the mobile base system;

FIG. 4 is a top view of the assembled mobile base system;

FIG. 4A is a closer view of a portion of the assembled mobile base system;

FIG. 5 is a bottom perspective view of an adjustable member;

FIG. 6 is a bottom perspective view of a locking member;

FIG. 7 is an exploded perspective view of a caster arrangement for use in the example of a mobile base system; and

FIG. 8 shows an alternative example of the invention.

FIG. 9 shows an alternative example of the invention.

FIG. 9A shows a detailed view of a portion of FIG. 9.

FIG. 9B shows a detailed view of another portion of FIG. 9.

### DETAILED DESCRIPTION

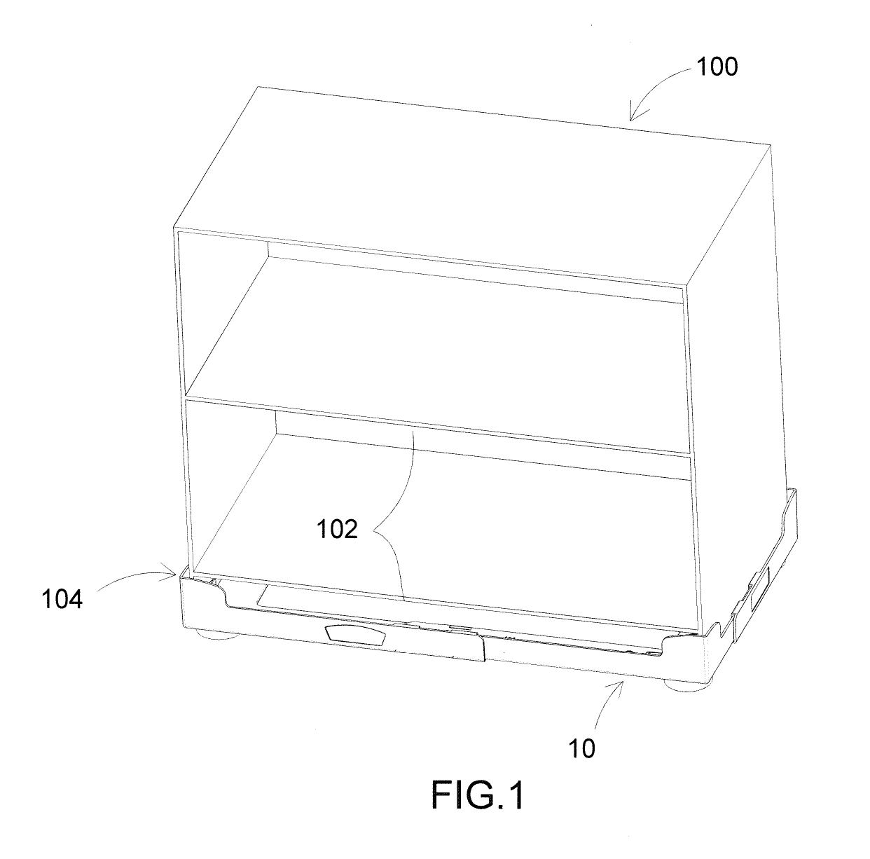

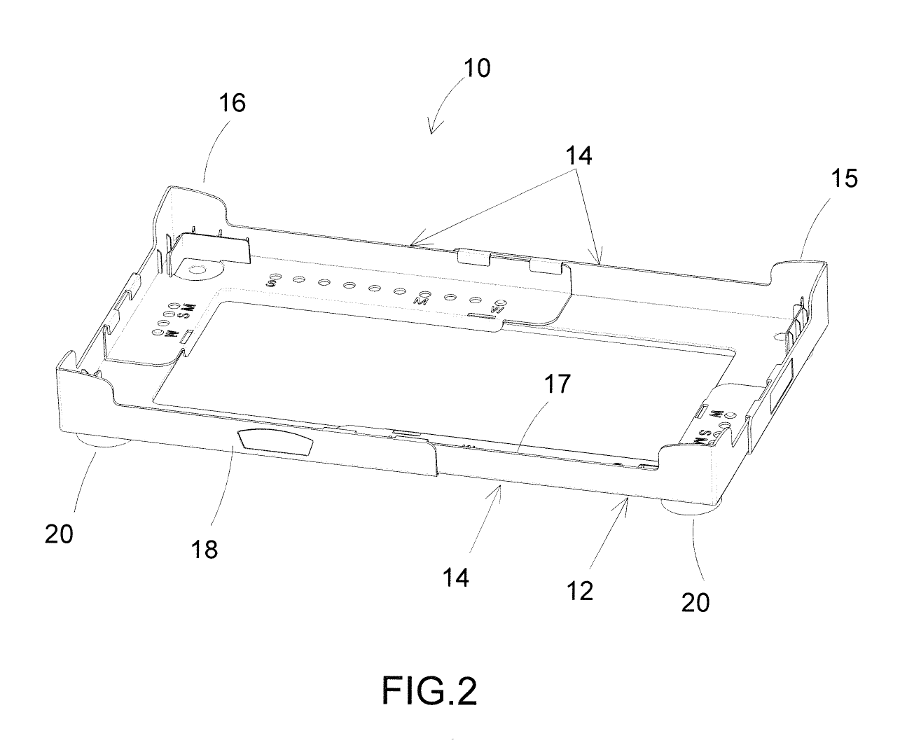

In an example of the invention, and with reference to several of the Figures, there is provided a separate mobile base system 10 that can be used with various point-of-sale displays 100, as shown in FIG. 1. The point-of-sale display 100 may be a box-like structure, such as formed of cardboard, plastic or other suitable material, and may have shelves 102 or other suitable structures (hooks, bins, etc.), to position products (not shown) in association with the display 100. Alternatively, the display 100 may simply have product information and advertisement thereon, in lieu of or in addition to actual products. The display 100 therefore provides a footprint at its base portion 104, which may be square, rectangular, triangular, round, polygonal or any other shape. To facilitate movement of the display 100 after it is constructed, the mobile base system 10 is provided. In an example, the mobile base system 10 is shown in FIG. 2, and includes a frame 12 formed of a plurality of members 14, which are adjustable to one another. The frame 12 may be an integral unit, or could include two, four or more separate members 14 that together form the frame in a desired configuration. In this example, the frame members 14 include four frame members 15-18 forming a rectangular frame 12. In this example, the frame members 15-18 interlock with one another and allow for adjustment of the mobile base system 10 in both width and length directions, allowing it to be fit with any of a variety of point-of-sale displays 100 having different square or rectangular base configurations It should be recognized that the same rectangular type frame 12 as shown in FIG. 2 could be constructed of only two frame members 14, with each being adjustable to one another and interlocked at a desired position, and allowing for adjustment of the length of the mobile base system 10. To facilitate movement of the mobile base system 10, the frame members 14 may include low-profile wheels or casters 20, such as mounted at the corners of each frame member 14. Upon construction of the frame 12, the wheels or casters 20 allow for simple movement of the mobile base system 10, along with the point-of-sale display 100 positioned thereon.

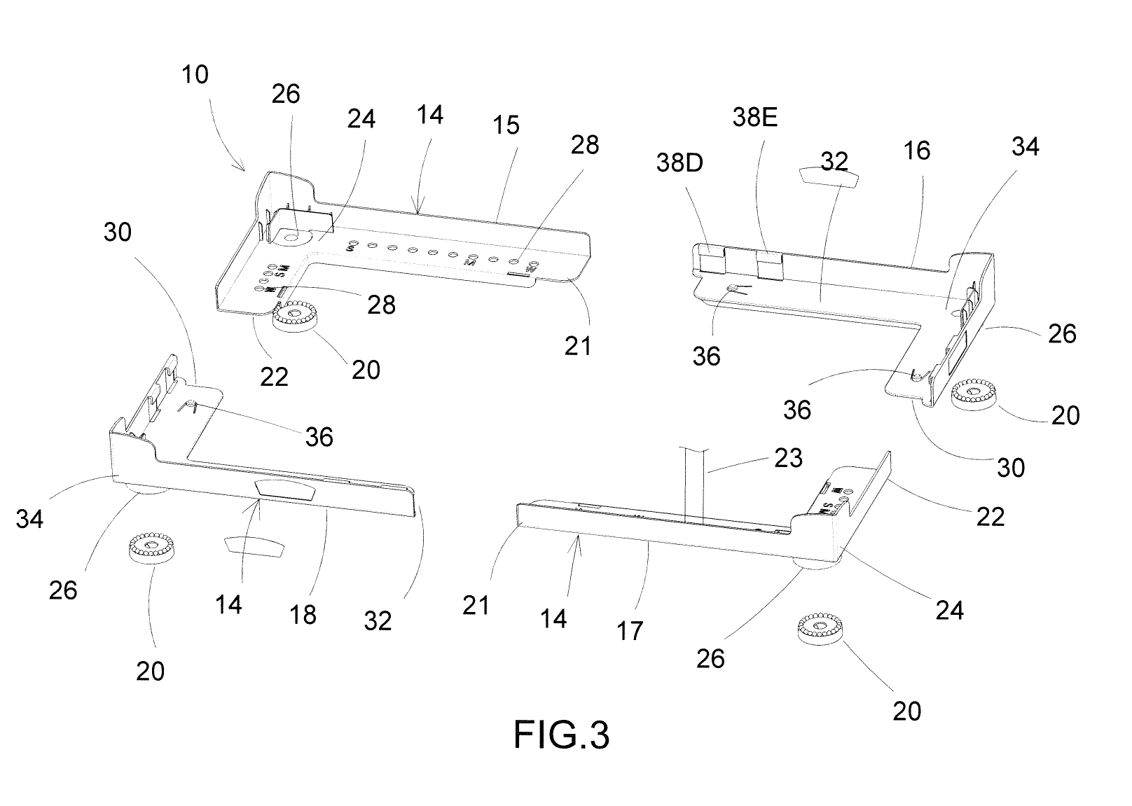

FIG. 3 is an exploded view of the mobile base system 10 showing the frame members 15-18, which are adjustable and lockable relative to one another. In the example shown, each of the frame members 15-18 are configured to allow for male/female type engagement, but any suitable configuration to allow for adjustment and locking of frame members is contemplated. For an example to accommodate square and rectangular base configurations 104, the adjustable members 15-18 are L-shaped brackets, having a first leg 21 and a second leg 22 extending away from a corner 24. In several of the frame members 15-18, the first leg 21 and second leg 22 each include a plurality of holes 28 that engage and interlock with a suitable male portion on the other frame members 15-18. Such a male portion may be a spring-biased button latch 36 for engaging the openings 28. The arrangement of each frame member relative to an adjacent member thus will depend on which hole the button latch 28 is engaged with, to allow for adjusting the size and dimensions of the rectangular frame 12. The corner 24 of the members 15-18 may include a recess 26 for receiving a low-profile caster 20 for moving the mobile base system 10.

In this example, there is a positive engagement system allowing interlocking between frame members 14, such as male/female type of positive engagement system. This may be as shown in this example, a series of holes 28 to engage a spring-biased button latch 36 on an adjacent frame member. Upon overlapping of the leg portions of adjacent frame members, the button latch 36 positively engages in one of the holes 28. This structure is merely an example, and other suitable arrangements for allowing adjustment and interlocking of the frame members are contemplated. The spring-biased button latch 36 may be unengaged by depressing the button through the holes 28 and sliding the members apart or to a different dimension.

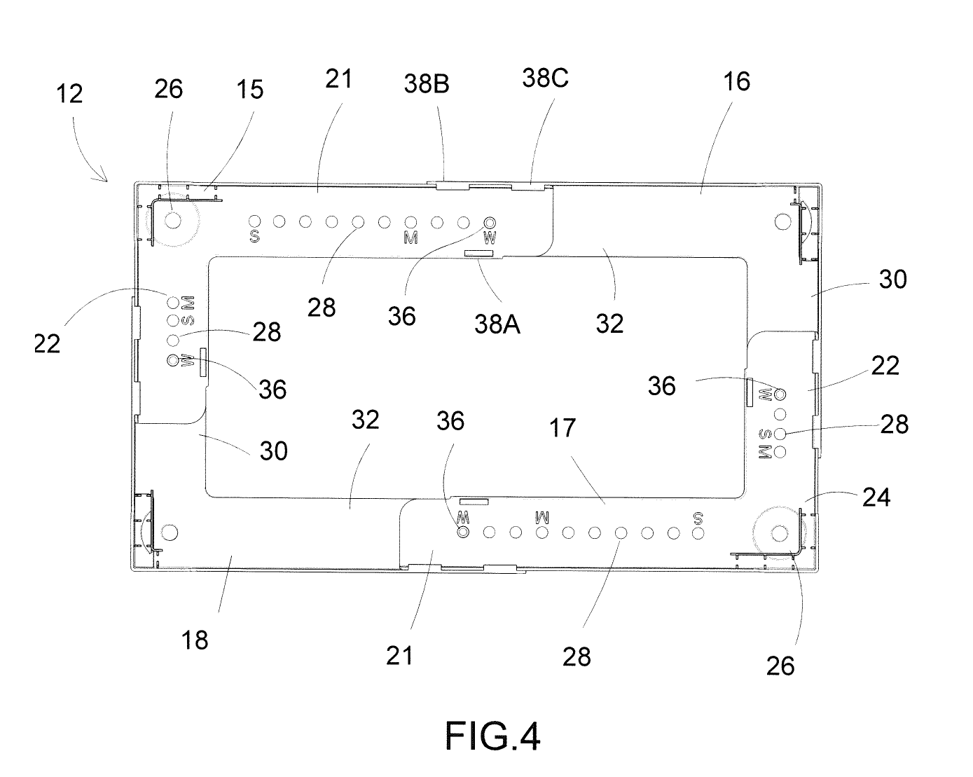

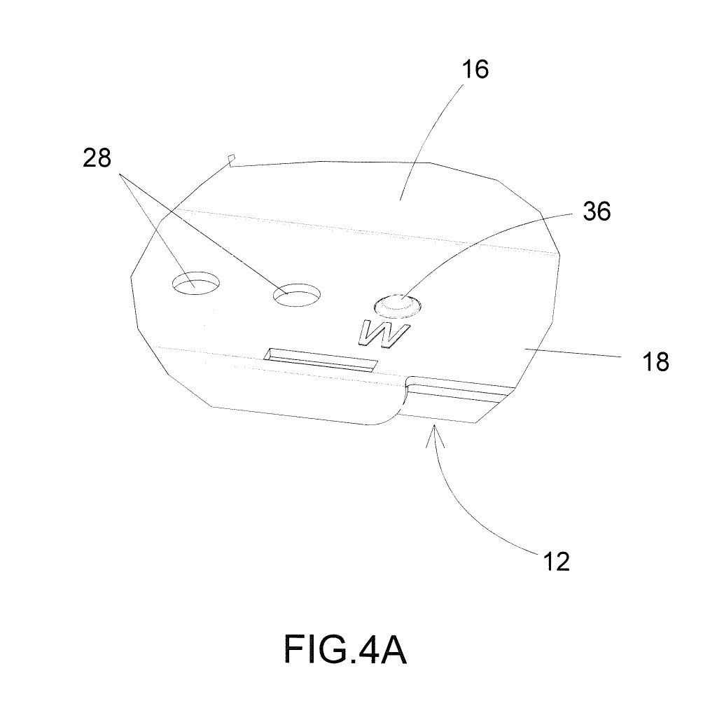

FIG. 4 illustrates the arrangement of the adjustable members 14 to form the rectangular frame 12. The rectangular frame 12 in this example is formed from adjustable members 15-18 secured leg-to-leg in a rectangular arrangement.

As shown in FIG. 4, each leg 30, 32 of the members 16 and 18 includes a bracket (generally 38) for receiving and securing a leg 21, 22 of the members 15 and 17 in a sliding arrangement. The bracket includes three lower ears 38 A-C shown in FIG. 4 and two upper ears 38D-E shown in FIG. 3 for receiving the frame member 14. These ears 38A-E receive a leg 21, 22 of the frame member 14 and prevent vertical displacement of the members 15-18 relative to one another.

As shown in FIG. 4A, the rectangular frame 12 is formed by sliding a leg of a frame member 14 adjustable member 16 into the brackets 38 and along the adjacent leg of the adjacent frame member 14. The spring-biased button latch 36 engages one of the openings 28 depending on the desired dimensions of the rectangular frame 12. The latch 36 prevents the legs from sliding relative to one another. The other leg of the frame member 14 is slid into one bracket or ears of the legs of an adjacent member 14 and locked by means of the spring-biased button latch 36. This process is repeated by sliding the legs of a second adjustable member 14 into the unused legs of the interlocked members 14, forming the square or rectangular shape shown in FIG. 4. Other suitable locking mechanisms are contemplated.

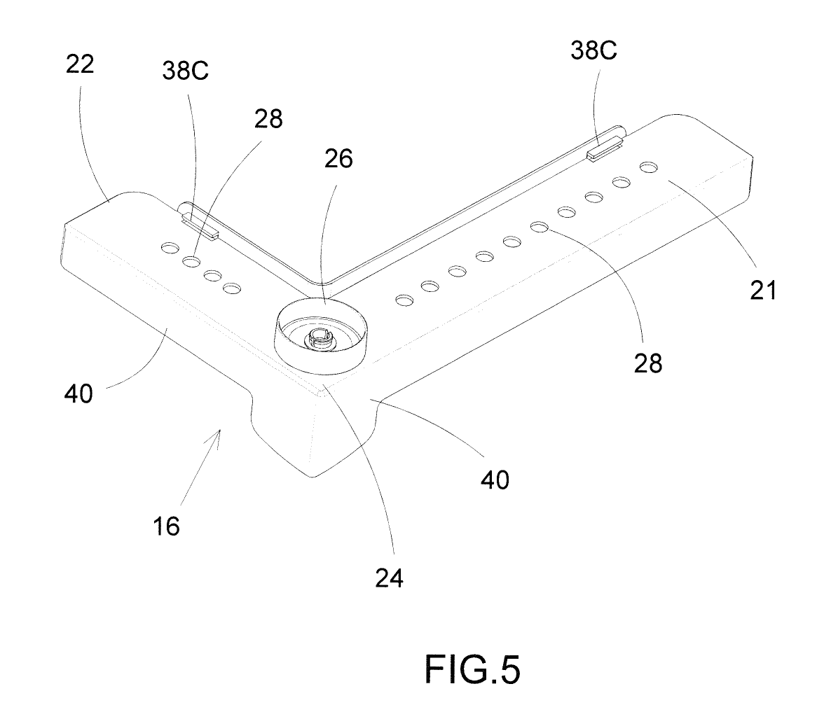

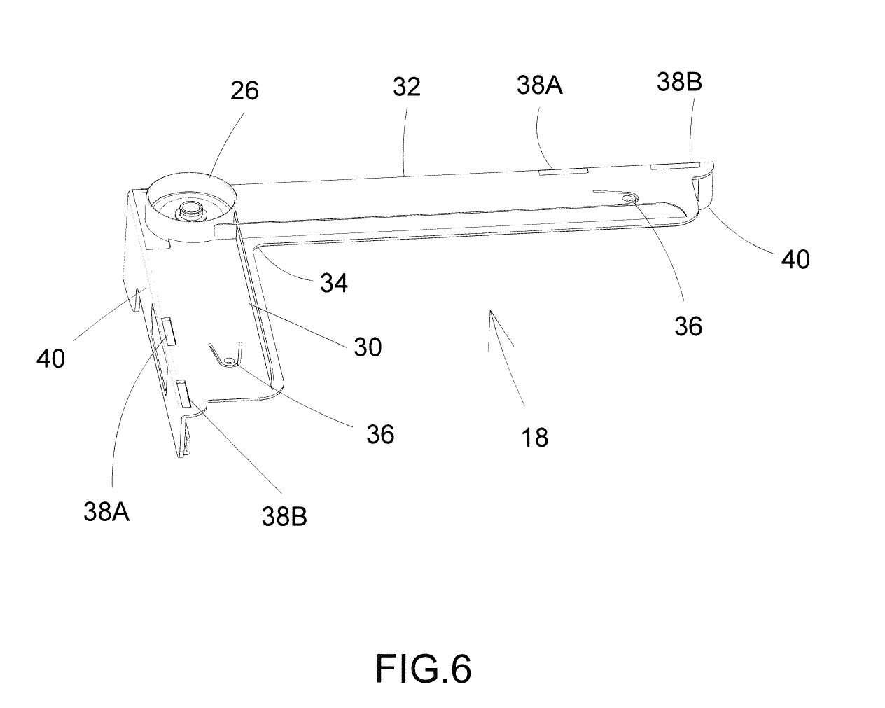

FIG. 5 shows an example of the frame members 15 and 17 having openings in each leg in further detail. FIG. 6 shows the frame members 16 and 18 having a push button male portion to interlock with the openings of members 15 and 17 in further detail. According to this arrangement, the frame members 14 may include a circumferential lip 40 extending perpendicular to the legs 21, 22 and 30, 32. During use of the mobile base system 10, a point-of-sale display unit 100 is placed on the rectangular frame 12 and the circumferential lip 40 will extend about and along the sides of the display unit, preventing horizontal movement of the display relative to the system 10. The system 10 may further or alternatively provide for adhesive, Velcro or other suitable connection of the display unit 100, which may automatically engage the display unit 100 upon placement in the mobile system 10. The arrangement further allows for movement of the mounted display system 100, with force simply applied to the display unit to begin movement as it is engaged to the mobile system 10. Alternatively, to facilitate supporting a display unit 100 in association with the mobile system 10, vertically extending members 23 one of a possible plurality shown in FIG. 3. The members 23 may be of any desired configuration to assist in supporting the display unit 100, and could add aesthetically to the appearance of the display. The circumferential lip 40 may also be configured to add to the appearance of the display unit 100, and may be colored, shaped, or have a printed design thereon, for example the lip may feature a logo or other advertising message. According to another alternative, the frame members 14 may include slots having a width for receiving the sides of the display. Alternatively, the display unit may be secured to the mobile base system 10 by bolts, adhesives such as glue or tape, screws, clips, hook-and-loop fasteners, or other structures. Additionally, a second, inner lip (not shown) may also be provided on the frame members 14, inward of the circumferential lip 40. During use, the sides of the display unit may be sandwiched between such an inner lip and the circumferential lip 40, providing additional stability when the display is moved. It should be recognized that other suitable configurations to stabilize and secure the display unit 100 may be used and are contemplated in the invention.

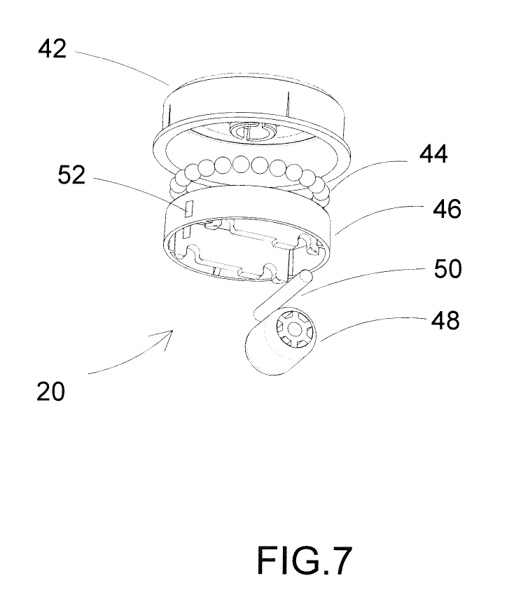

FIG. 7 shows an exploded perspective view of the low profile caster 20. The caster 20 includes a base 42 receivable within the recess 26, a plurality of bearings 44, a bracket 46 that rests on the bearings 44 allowing the bracket 46 to freely rotate relative to the base 42, and a roller 48 connected to the bracket 46 by means of an axle 50 that allows the roller 48 to rotate. The base 42 of the caster 20 is received in the recesses 26 of the rectangular frame and the roller 48 allows the mobile base system 10 to be easily moved. The bracket 46 is rotatable about the base 42, allowing the system 10 to turn and move in other directions. In association with the mobile system 10, a brake mechanism, such as a boot or tab 52 which may be provided to extend into engagement with the floor, or other suitable brake mechanism may be provided. Alternatively, a brake mechanism could be provided on the frame 12 to prevent unwanted movement of the mobile system 10, once it is positioned at the desired location.

Alternative arrangements of the mobile base system are also contemplated. According to one alternative, one or more intermediate members may be positioned between the locking and adjustable members, allowing for greater variation in width and length of the frame 12.

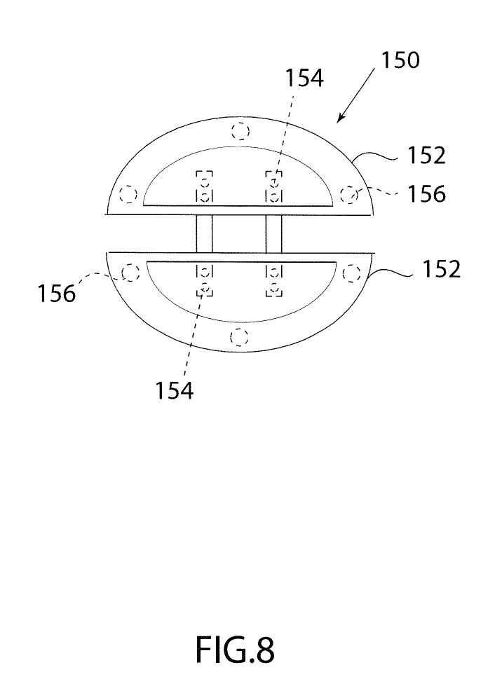

According to other alternatives, the frame 12 may be of a different shape, such as angular, arcuate, straight or of any other shape, allowing for accommodation of displays with various alternative shapes, such as triangular, circular, or other shapes. In FIG. 8, a circular frame 150 is shown to include first and second arcuate members 152, that may be configured to engage a display unit having a round or oval base configuration. The members 152 may be adjustable via one or more adjustment members 154, extending between members 152. Members 152 may have casters 156, allowing movement thereof. Other aspects of different examples may also be used in such a configuration.

According to another alternative, the members 16, 18 have an inner lip but not a circumferential lip and the display covers the inner lip when placed on the mobile base system 10.

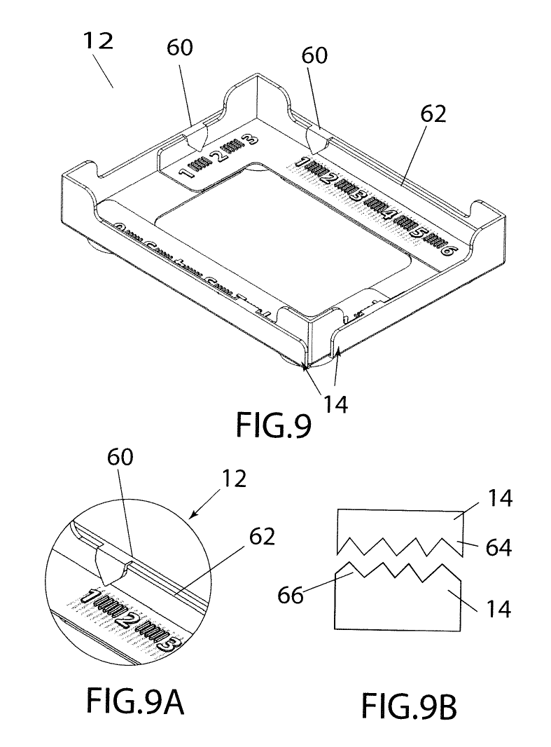

FIG. 9 shows yet another alternative in which the frame 12 includes frame members 14. In this arrangement, the frame members 14 engage and interlock with one another using a ratchet system, shown in more detail in FIG. 9B. A location indicator arrow 60 and indicia 62 is shown which aids a user in the more precise positioning of the frame members 14 relative to each other. A ratchet arrangement is provided for allowing almost infinite adjustment of the frame members 14 relative to one another, and also provide an effective locking arrangement. The ratchet type system may be provided as a tooth and comb type of arrangement, a sliding arrangement, or a groove and tongue arrangement. FIG. 9A shows a closer view of the location indicator arrow 60 which is used to precisely position the members 14 relative to each other along various measurement locations 62 on the adjustment member 16. Here, the measured locations 62 may be of any desired distance and may include any amount of incremental indicators at any desired increment between measured locations 62.

FIG. 9B depicts an example of the ratchet type arrangement associated with the frame members 14. In this embodiment, the ratchet arrangement is formed by opposing teeth 64 and 66 formed on adjacent legs of the frame members 14, respectively, that interlock with each other. This allows the members 16 and 18 to have a nearly infinite adjustment between the frame members 14 to adjust the size of the frame 12 to match a given display unit. The teeth 64 and 66 are positioned in such a way as to securely position the members 14 with respect to each other. Alternatively, the frame members 14 may simply be arranged in sliding engagement with one another, where friction between the frame members upon positioning of the display unit on the base 10 holds the frame members 14 in place relative to adjacent members 14.

Other arrangements, such as the position, type, number and arrangement of casters are also envisioned. It is also envisioned that not all of the corners of the mobile base system 10 may have wheel assemblies, such as rolling casters, and other suitable configurations to allow support and movement are contemplated.

Various types of locking connectors between adjacent members are also contemplated. The spring-biased button latch and perforated holes are used in the illustrated example as they are inexpensive and easy to use. However, other connectors such as bolts, pins, adhesives, or permanent connectors may also be used.

The rectangular frame is shown as being adjustable between a fixed number of positions. However, it is contemplated that the frame may have more (up to infinite adjustability, for example by a screw drive) or fewer (as few as zero, for example a permanent connection) adjustment options.

According to an example of the mobile base system the members are made of injection molded plastic. However, it is further contemplated that the members may be made of different materials, including stamped sheet metal, such as aluminum or steel.

What is claimed is:

1. A mobile base system for supporting a separate display unit, comprising a frame system including at least two frame members, with the frame system adjustable to match the base configuration of a plurality of separate display units having different dimensions, the frame system further including a transport system to allow the frame system to be moved with little resistance when supporting the separate display unit.

2. The mobile base system of claim 1, wherein the at least two frame members which are adjustably connected by a positive engagement system, wherein after adjustment of the frame members relative to one another, the positive engagement system secures the at least two frame members in position.

3. The mobile base system of claim 2, wherein the at least two frame members include leg portions which overlap with leg portions of the another frame member and the positive engagement system comprises male/female structure formed on the leg portions respectively.

4. The mobile base system of claim 1, wherein the frame system includes at least four frame members to allow adjustment of both the length and width of the frame system.

5. The mobile base system of claim 1, wherein the transport system includes a plurality of wheels.

6. The mobile base system of claim 1, further comprising a brake system to prevent the unwanted movement of the mobile base system.

7. The mobile base system of claim 1, further comprising stabilizing structures associated with the mobile base system to stabilize a display unit positioned thereon.

8. The mobile base system of claim 1, wherein at least one of the frame members includes a bracket system for receiving and securing a leg of the another frame member in a sliding arrangement.

9. The mobile base system of claim 8, wherein the bracket system includes lower ears and upper ears for receiving the leg of another frame member and prevent vertical displacement of the frame members relative to one another.

10. A method to implement positioning of a display unit, comprising providing a display unit having a base configuration, providing an adjustable frame system including at least two frame members, adjusting the at least two frame members relative to one another to substantially match the base configuration of the display unit, positioning the display unit on the frame system so as to be engaged thereby, and providing a transport system in association with the frame system to allow movement of the display unit in the frame system with little resistance.

11. The method of claim 10, wherein the at least two frame members include structure to engage one another in an adjustable manner.

12. The method of claim 10, wherein the frame system includes at least four frame members to allow adjustment of both the length and width of the frame system.

13. The method of claim 10, wherein the at least two frame members include leg portions which overlap with leg portions of the another frame member and the positive engagement system comprises male/female structure formed on the leg portions respectively.

14. The method of claim 10, wherein the transport system includes a plurality of wheels.

15. The method of claim 10, further comprising locking the position of the adjustable frame system after transport to a desired location.

16. The method of claim 10, wherein the display unit is stabilized in the adjustable frame system by stabilizing structures associated therewith.

17. A mobile base system for supporting separate point of purchase display units having different dimensional characteristics, comprising a frame system including at least two frame members defining a base configuration, with the at least two frame members being engageable with one another and adjustable to modify the base configuration to match the base of a separate display unit, the frame system further including a transport system to allow the frame system to be moved with little resistance when supporting the separate display unit.

18. The mobile base system of claim 17, wherein at least four frame members include leg portions which overlap with leg portions of another frame member and are adjustably connected to one another by a positive engagement system, wherein the positive engagement system comprises male/female structure formed on the leg portions respectively.

19. The mobile base system of claim 17, further comprising a brake system to prevent the unwanted movement of the mobile base system.

20. The mobile base system of claim 17, further comprising stabilizing structures associated with the mobile base system to stabilize a display unit positioned thereon.
